(19) United States
(12) Patent Application Publication
(10) Pub. No.: US 2020/0201090 A1
(43) Pub. Date: Jun. 25, 2020

(54) DISPLAY DEVICE AND METHOD FOR MANUFACTURING THE SAME

(71) Applicant: InnoLux Corporation, Miao-Li County (TW)

(72) Inventors: Shun-Chu CHEN, Miao-Li County (TW); Chiung-Chieh KUO, Miao-Li County (TW); Kuan-Hung KUO, Miao-Li County (TW); Chiu-Lien YANG, Miao-Li County (TW); Jiou-Teng LAI, Miao-Li County (TW); Chi-Han HSIEH, Miao-Li County (TW); Yi-Ching HUANG, Miao-Li County (TW)

(21) Appl. No.: 16/693,712

(22) Filed: Nov. 25, 2019

(30) Foreign Application Priority Data
Dec. 25, 2018 (CN) 201811587362.X

(51) Int. Cl. G02F 1/1335; B32B 27/40; B32B 27/28

(52) U.S. Cl. CPC G02F 1/1335; B32B 27/40; G02F 2001/133357; G02F 2202/22; B32B 27/285

(57) ABSTRACT

A display device and a manufacturing method of the same are provided. The display device includes a display panel and a polarizer disposed on the display panel. The display panel includes a first substrate, a second substrate, a display medium, and a self-healing layer including a self-healing polymer material. The display medium is disposed between the first substrate and the second substrate. The self-healing layer is formed on at least a surface of the first substrate or the second substrate.

### CROSS REFERENCE TO RELATED APPLICATIONS

This application claims priority of Chinese Patent Application 201811587362.X, filed on Dec. 25, 2018 the entirety of which is incorporated by reference herein.

### BACKGROUND

### Technical Field

The present disclosure relates to a display device and a manufacturing method of the same, and in particular, it relates to a display device having a self-healing layer and a manufacturing method of the same.

### Description of the Related Art

In the manufacturing processes of display devices, defects may be generated in the as-formed components or structures due to contamination of environmental particles or extraneous matters in each of the processing steps for forming these components or structures. As a result, abnormalities such as light leakage or dark spots may occur in the display screens of the display panels. Therefore, inspection stations are usually arranged in the manufacturing processes of display devices for defect confirmation and for the following additional repairing processing steps.

Accordingly, the industry requires display devices with reduced defects as well as the manufacturing methods of the same.

### SUMMARY

The present disclosure relates to a display device and a manufacturing method of the same. In the embodiments, the display panel of the display device includes a self-healing layer, and the self-healing layer includes a self-healing polymer material. In some embodiments, when defects are generated in the manufacturing processes, the self-healing layer including the self-healing polymer material can heal by itself, and thus the qualities and/or the manufacturing yields of the display devices can be improved.

In accordance with some embodiments of the present disclosure, a display device is provided. The display device includes a display panel and a polarizer, and the polarizer is disposed on the display panel. The display panel includes a first substrate, a second substrate, a display medium layer, and a self-healing layer. The display medium layer is disposed between the first substrate and the second substrate. The self-healing layer is formed on at least a surface of the first substrate or the second substrate, and the self-healing layer includes a self-healing polymer material.

In accordance with some embodiments of the present disclosure, a manufacturing method of a display device is provided. The manufacturing method of the display device includes the following steps: providing a base plate assembly; cutting the base plate assembly to form a plurality of display panels; and disposing a polarizer on at least one of the plurality of display panels to form the display device. The base plate assembly includes a first base plate, a second base plate, and a self-healing layer. The first base plate has a first surface and a second surface opposite to the first surface. The self-healing layer is coated on at least a surface of the first base plate or the second base plate, and the self-healing layer includes a self-healing polymer material.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1 shows a cross-sectional view of a display device in accordance with some embodiments of the present disclosure;

FIG. 2 shows a cross-sectional view of a display device in accordance with some embodiments of the present disclosure;

FIG. 3 shows a cross-sectional view of a display device in accordance with some embodiments of the present disclosure;

FIG. 4 shows a cross-sectional view of a display device in accordance with some embodiments of the present disclosure; and

FIG. 5, FIG. 6A, FIG. 6B, FIG. 6C, FIG. 6D, FIG. 6E, FIG. 6F, FIG. 6G, FIG. 6H, FIG. 6I, FIG. 6J, FIG. 6K, FIG. 6L, FIG. 7, FIG. 8, FIG. 9A, and FIG. 9B illustrate various stage of a manufacturing process of a display device in accordance with some embodiments of the present disclosure.

### DETAILED DESCRIPTION

The following description of the embodiments of the present disclosure is made with reference to the accompanying drawings. It should be noted that the detailed structures and processing steps provided in the embodiments are merely for exemplification and not for limiting the scope. The present disclosure can be realized by applying various features, components, methods, and parameters. One of ordinary skills in the art may modify or change the structures and steps according to actual needs without departing from the spirit and scope of the present disclosure. The accompanying drawings are simplified with some secondary elements omitted for clearly describing the embodiments. Thicknesses of some layers and regions in the drawings may be enlarged for clarity, and the elements sharing similar or the same labels in the drawings are similar or the same elements.

The description of a first material layer disposed over or on a second material layer may include embodiments in which the first material layer and the second material layer are in direct contact, and may also include embodiments in which additional material layer(s) may be disposed between the first material layer and the second material layer, such that the first material layer and the second material layer may not be in direct contact.

The description of two adjacent first components indicates the two more adjacent first components in the plurality of first components, and other component(s) that is not the first component may be disposed between these two more adjacent first components.

In addition, all or some of the technical features of one or more embodiments in the present disclosure may be exchanged with and/or combine with all or some of the technical features of one or more other embodiments in the present disclosure so as to generate additional one or more embodiments of the present disclosure.

The following provides various embodiments of the display device of the present disclosure. However, the detailed structures and processing steps provided in the embodiments are merely for exemplification and not for limiting the scope.

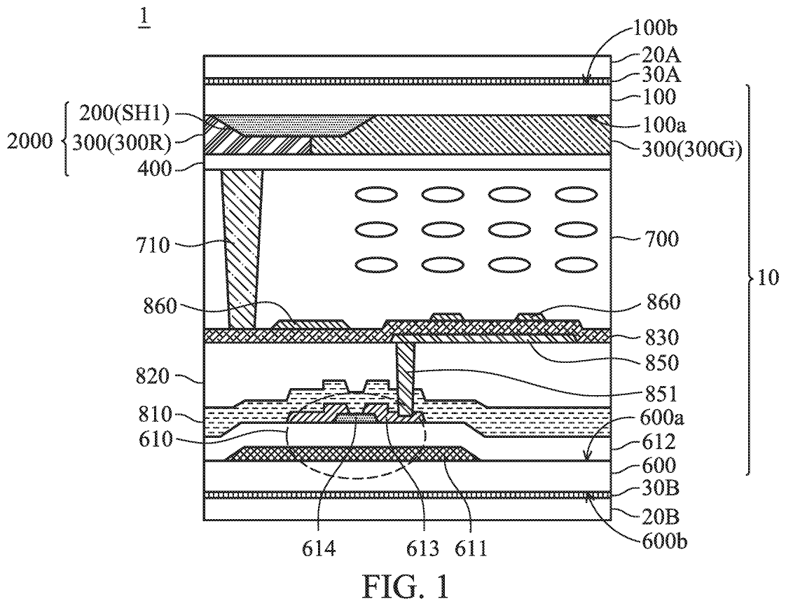

FIG. 1 shows a cross-sectional view of a display device 1 in accordance with some embodiments of the present disclosure. It should be noted that the cross-sectional view as shown in FIG. 1 merely shows a local region of the display device 1, for example, a sub-pixel region.

As shown in FIG. 1, in some embodiments, the display device 1 includes a display panel 10 and a polarizer 20A, and the polarizer 20A is disposed on the display panel 10. The display panel 10 includes a first substrate 100, a second substrate 600, and a display medium layer 700, and the display medium layer 700 is disposed between the first substrate 100 and the second substrate 600. The first substrate 100 has a first surface 100a and a second surface 100b, the first surface 100a is facing towards the display medium layer 700, and the second surface 100b is opposite to the first surface 100a. The polarizer 20A is disposed on the second surface 100b of the first substrate 100. The display panel 10 further includes a self-healing layer, and the self-healing layer is formed on at least a surface of the first substrate 100 or the second substrate 600. For example, as shown in FIG. 1, the display panel 10 includes a self-healing layer SH1 formed on the first surface 100a of the first substrate 100. In some embodiments, the self-healing layer SH1 may include a self-healing polymer material. The self-healing polymer material includes a polyrotaxane material, a polyurethane (PU) material, a polyether-thiourea material, or a combination thereof.

As shown in FIG. 1, in some embodiments, the display device 1 further includes a polarizer 20B, and the display panel 10 is disposed between the polarizer 20A and the polarizer 20B. As shown in FIG. 1, in some embodiments, the display device 1 further includes an adhesive layer 30A and an adhesive layer 30B, the polarizer 20A is adhered to the display panel 10 through the adhesive layer 30A, and the polarizer 20B is adhered to the display panel 10 through the adhesive layer 30B.

Specifically, as shown in FIG. 1, in some embodiments, the display panel 10 further includes a color filter structure 2000 formed on the first surface 100a of the first substrate 100. For example, the color filter structure 2000 includes a plurality of layers, for example, a light-shielding layer 200, a color resist layer 300, and a planarization layer 400. According to some embodiments, at least one of the plurality layers of the color filter structure 2000 may be the self-healing layer SH1. For simplicity of description, only the light-shielding layer 200 is marked as the self-healing layer SH1 in FIG. 1. According to some embodiments, the self-healing layer SH1 may include a photoresist material. According to some embodiments, two or more than two layers in the plurality layers of the color filter structure 2000 may be the self-healing layer SH1. For example, the self-healing layer SH1 may be the light-shielding layer 200, the color resist layer 300, and planarization layer 400, or a combination thereof.

As shown in FIG. 1, in some embodiments, the display panel 10 may include the light-shielding layer 200, the light-shielding layer 200 is disposed on the first surface 100a of the first substrate 100, and the light-shielding layer 200 is, for example, a patterned black matrix layer having a predetermined pattern. In some embodiments, the light-shielding layer 200 may include a photoresist material and a black colorant, and the black colorant may include, for example, a black pigment and/or a black dye, and/or carbon black, but the present disclosure is not limited thereto. In some embodiments, the light-shielding layer 200 may further include a self-healing polymer material, hence the light-shielding layer 200 may be the self-healing layer SH1 including a self-healing polymer material.

As shown in FIG. 1, in some embodiments, the display panel 10 may include a color resist layer 300, and the color resist layer 300 is disposed on the first surface 100a of the first substrate 100. In some embodiments, the color resist layer 300 may include a photoresist material and a colorant. As shown in FIG. 1, in some embodiments, the color resist layer 300 may include a plurality of color resists, for example, a red color resist 300R including a red pigment and/or a red dye, a green color resist 300G including a green pigment and/or a green dye, and a blue resist (not shown) including a blue pigment and/or a blue dye. As such, the color resist layer 300 having a predetermined pattern is constructed, but the present disclosure is not limited thereto.

As shown in FIG. 1, in some embodiments, the display panel 10 may include a planarization layer 400, and the planarization layer 400 is disposed on the first surface 100a of the first substrate 100. As shown in FIG. 1, the planarization layer 400 covers the light-shielding layer 200 and the color resist layer 300, and the planarization layer 400 has a planarized surface. In some embodiments, the planarization layer 400 may include a photoresist material and a transparent resin material, for example, a transparent photoresist material, but the present disclosure is not limited thereto. The planarization layer 400 may be un-patterned or patterned.

As described above, the self-healing layer SH1 may be a single layer or include a plurality of layers. The self-healing layer SH1 may be the light-shielding layer 200, the color resist layer 300, the planarization layer 400, or a combination thereof. When the self-healing layer SH1 includes a plurality of layers, at least one of the plurality layers may include a self-healing polymer material. For example, the light-shielding layer 200 may include a self-healing polymer material, while the color resist layer 300 and the planarization layer 400 do not include any self-healing polymer material. In another example, the color resist layer 300 may include a self-healing polymer material, while the light-shielding layer 200 and the planarization layer 400 do not include any self-healing polymer material.

In some embodiments, the display medium layer 700 may be a liquid crystal layer including a plurality of liquid crystal molecules, but the present disclosure is not limited thereto. According to some embodiments, the display medium layer 700 may include organic light emitting diodes (OLEDs), inorganic light emitting diodes, or quantum dot light emitting diodes. As shown in FIG. 1, in some embodiments, the display panel 10 may further include a spacer 710, and the spacer 710 is disposed between the first substrate 100 and the second substrate 600.

The display panel 10 of the present disclosure is not limited to any particular types. As shown in FIG. 1, in some embodiments, the display panel 10 may be a fringe field switching (FFS) type display panel. Besides, in some embodiments, the display panel 10 may be an in-plane switching (IPS) type display panel, a vertical alignment (VA) type liquid crystal display device, or a twisted nematic (TN) type liquid crystal display device, and the details are not repeated herein. The FFS type display panel as shown in FIG. 1 is taken as an example, the display panel 10 may further include a transistor component 610, a pixel electrode 850, a common electrode 860, a dielectric layer 810, a planarization layer 820, and a dielectric layer 830. The transistor component 610 is disposed on the first surface 600a of the second substrate 600, and the dielectric layer 810 and the planarization layer 820 are disposed on the transistor component 610. The pixel electrode 850 and the common electrode 860 are disposed on the planarization layer 820, and the dielectric layer 830 is disposed between the pixel electrode 850 and the common electrode 860. For example, the pixel electrode 850 is disposed on the planarization layer 820, and the common electrode 860 is disposed on the dielectric layer 830. As shown in FIG. 1, in some embodiments, the transistor component 610 includes a gate electrode 611, a gate dielectric layer 612, a source and drain layer 613, and an active layer 614. The pixel electrode 850 is electrically connected to the source and drain layer 613 of the transistor component 610 through the conductive structure 851. The transistor component 610 as shown in FIG. 1 is merely for exemplification, transistor components having various different structures may be used according to actual needs, and the details are not repeated herein.

As shown in FIG. 1, in some embodiments, the light-shielding layer 200, the color resist layer 300, and the planarization layer 400 may construct the color filter structure 2000, and the color filter structure 2000 and the transistor component 610 are located on the first substrate 100 and the second substrate 600, respectively, and the first substrate 100 and the second substrate 600 are located on two opposite sides of the display medium layer 700.

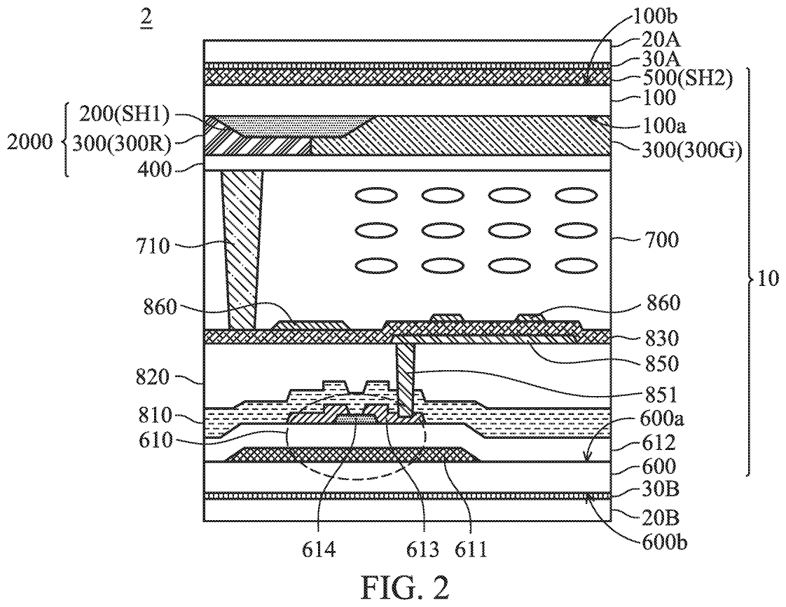

FIG. 2 shows a cross-sectional view of a display device 2 in accordance with some embodiments of the present disclosure. The elements in the present embodiment sharing similar or the same labels with those in the previous embodiment are similar or the same elements, and the description of which is omitted.

As shown in FIG. 2, in some embodiments, the display panel 10 may include an antistatic layer 500, and the antistatic layer 500 is disposed between the first substrate 100 and the polarizer 20A. As shown in FIG. 2, in some embodiments, the antistatic layer 500 is disposed on the second surface 100b of the first substrate 100. In some embodiments, the antistatic layer 500 is formed on the second surface 100b of the first substrate 100 and located between the first substrate 100 and the adhesive layer 30A, and the antistatic layer 500 is also a self-healing layer SH2 and may include a self-healing polymer material. In some embodiments, the antistatic layer 500 includes a conductive material, and the conductive material may be, for example, a conductive polymer material. The conductive polymer material may be, for example, a polythiophene-based compound, and the polythiophene-based compound may include PEDOT:PSS, but the present disclosure is not limited thereto. The antistatic layer 500 may further include other conductive materials, e.g. carbon nanotubes, but the present disclosure is not limited thereto. In some embodiments, the antistatic layer 500 as shown in FIG. 2 is the self-healing layer SH2, and the light-shielding layer 200, the color resist layer 300, and the planarization layer 400 as shown in FIG. 2 may not include any self-healing polymer material and are not self-healing layers. In some embodiments, the antistatic layer 500 as shown in FIG. 2 is the self-healing layer SH2, and at least one of the light-shielding layer 200, the color resist layer 300, and the planarization layer 400 as shown in FIG. 2 may optionally include a self-healing polymer material and serve as a self-healing layer. For convenience of description, the light-shielding layer 200 as shown in FIG. 2 is marked as the self-healing layer SH1; however, the light-shielding layer 200 may not be a self-healing layer.

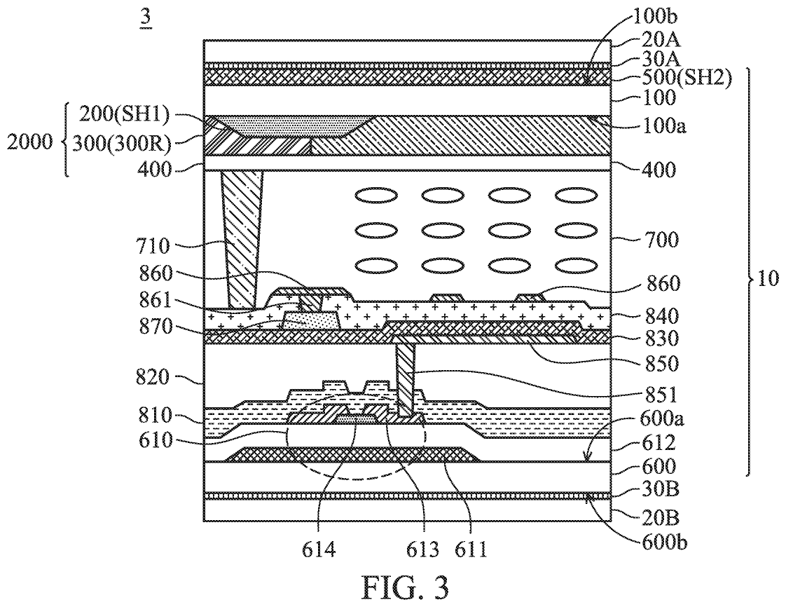

FIG. 3 shows a cross-sectional view of a display device 3 in accordance with some embodiments of the present disclosure. The elements in the present embodiment sharing similar or the same labels with those in the previous embodiments are similar or the same elements, and the description of which is omitted.

As shown in FIG. 3, in some embodiments, in the display device 3, the display panel 10 further includes a touch electrode layer. Specifically, the display panel 10 further includes a dielectric layer 840 and a metal wiring layer 870, and the common electrode 860 is disposed on the dielectric layer 840. In addition, the common electrode 860 may serve as a touch electrode layer at the same time. In other words, the display panel 10 further includes a touch electrode layer, and the common electrode 860 (i.e., the touch electrode layer) is electrically connected to the metal wiring layer 870 through the conductive structure 861 to transmit the touch signals to the touch control unit (not shown in drawings) in the display device 3.

According to some embodiments of the present disclosure, in the display device 3 as shown in FIG. 3, at least one or more than one of the light-shielding layer 200, the color resist layer 300, the planarization layer 400, and the antistatic layer 500 may be the self-healing layer including a self-healing polymer material. The details are as aforementioned and are not repeated herein. For convenience of description, the light-shielding layer 200 as shown in FIG. 3 is marked as the self-healing layer SH1; however, the light-shielding layer 200 may not be a self-healing layer.

According to some embodiments, the display device 3 as shown in FIG. 3 is, for example, a FFS type liquid crystal display device with embedded touch components.

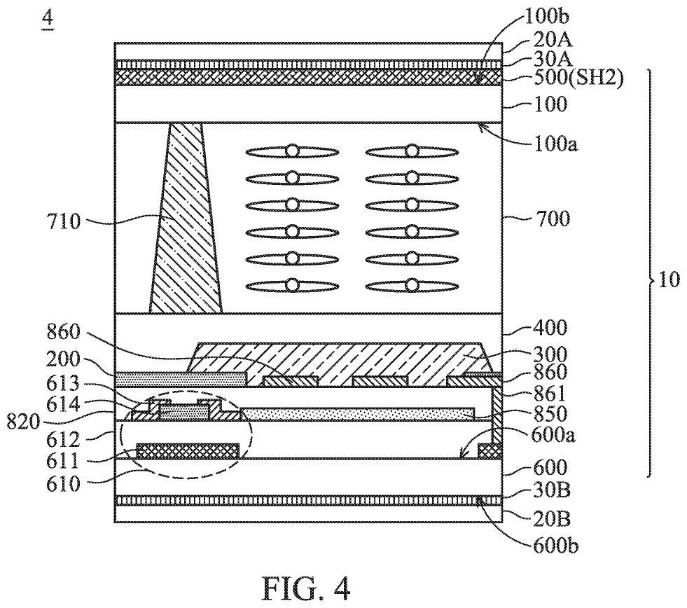

FIG. 4 shows a cross-sectional view of a display device 4 in accordance with some embodiments of the present disclosure. The elements in the present embodiment sharing similar or the same labels with those in the previous embodiments are similar or the same elements, and the description of which is omitted.

As shown in FIG. 4, in the display device 4, the light-shielding layer 200, the color resist layer 300, the planarization layer 400, and the transistor component 610 may be disposed on the same surface (e.g., the first surface 600a) of the same second substrate 600.

Specifically, as shown in FIG. 4, in some embodiments, the light-shielding layer 200 and the common electrode 860 are disposed on the planarization layer 820, and the color resist layer 300 is disposed on the common electrode 860 and the light-shielding layer 200.

According to some embodiments of the present disclosure, in the display device 4 as shown in FIG. 4, at least one or more than one of the light-shielding layer 200, the color resist layer 300, the planarization layer 400, and the antistatic layer 500 may be the self-healing layer including a self-healing polymer material. The details are as aforementioned and are not repeated herein.

Some embodiments of the present disclosure further provide a manufacturing method of a display device. The manufacturing method of the display device includes the following steps: providing a base plate assembly; cutting the base plate assembly to form a plurality of display panels; and disposing a polarizer on at least one of the plurality of display panels to form the display device. The base plate assembly includes a first base plate, a second base plate, and a self-healing layer. The first base plate has a first surface and a second surface opposite to the first surface. The self-healing layer is coated on at least a surface of the first base plate or the second base plate, and the self-healing layer includes a self-healing polymer material. The details of the self-healing polymer material are as aforementioned and are not repeated herein.

The following provides various embodiments of the manufacturing method of the display device of the present disclosure. However, the detailed structures and processing steps provided in the embodiments are merely for exemplification and not for limiting the scope.

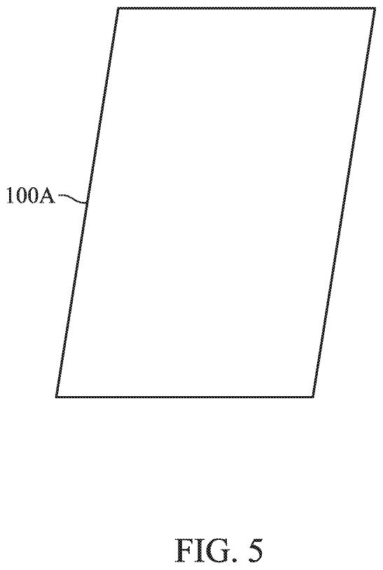

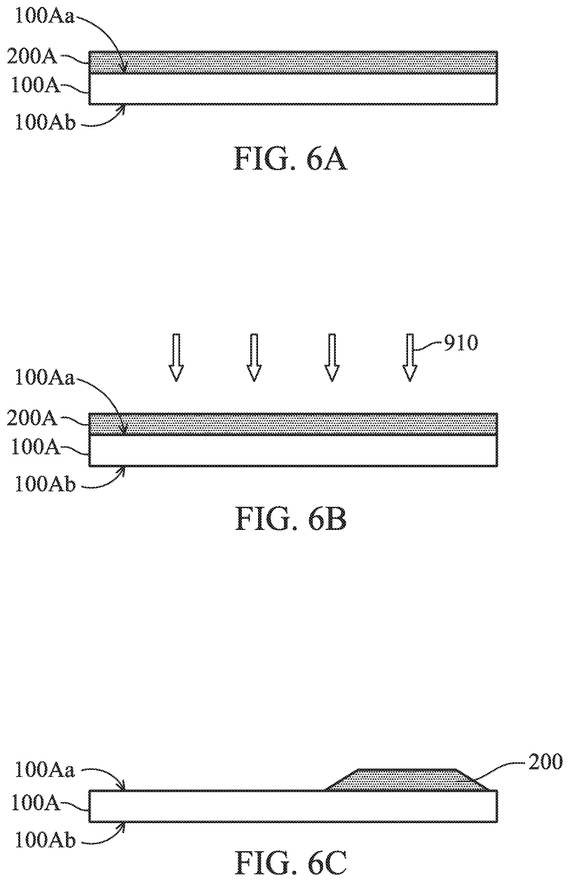

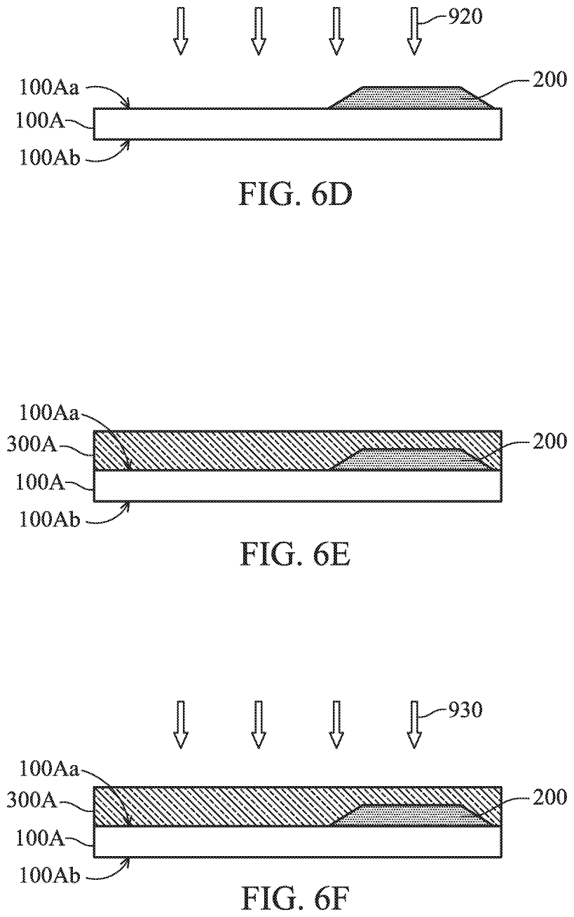

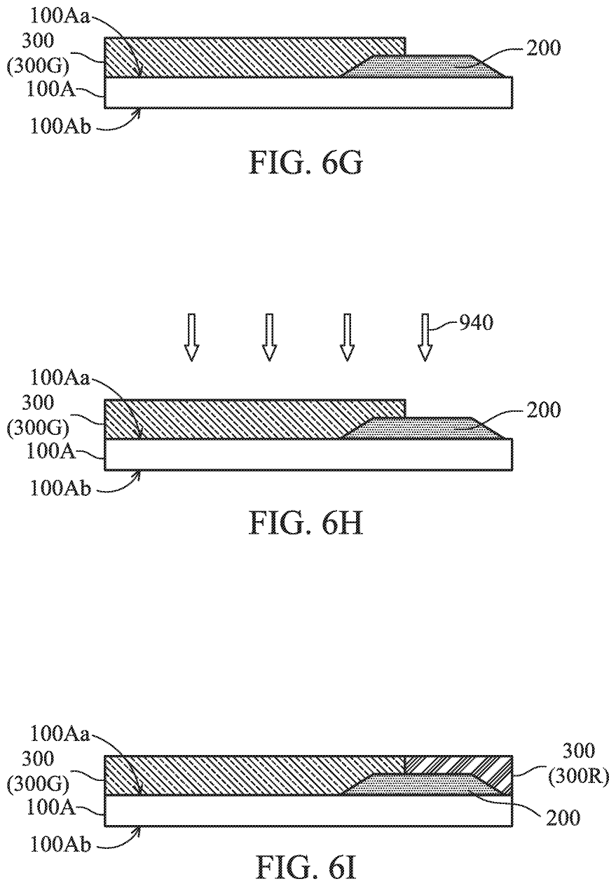

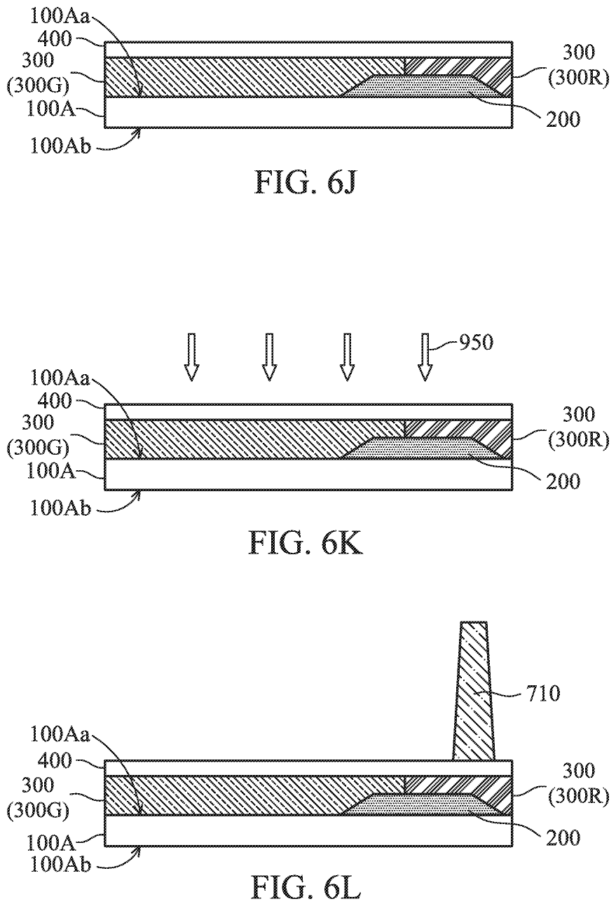

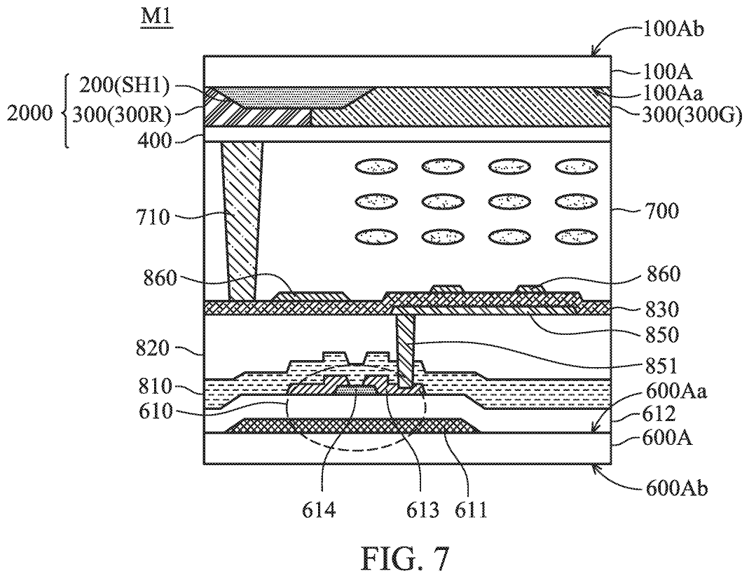

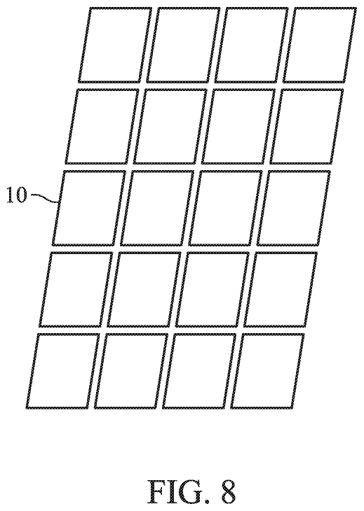

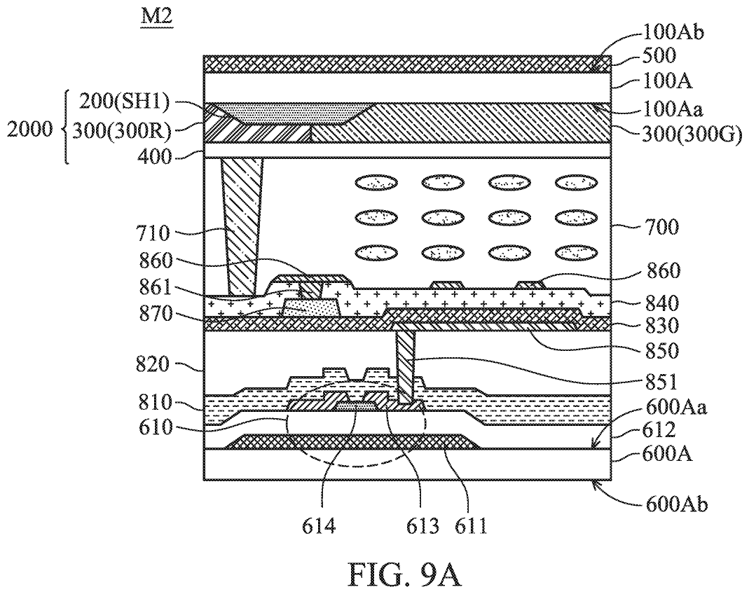

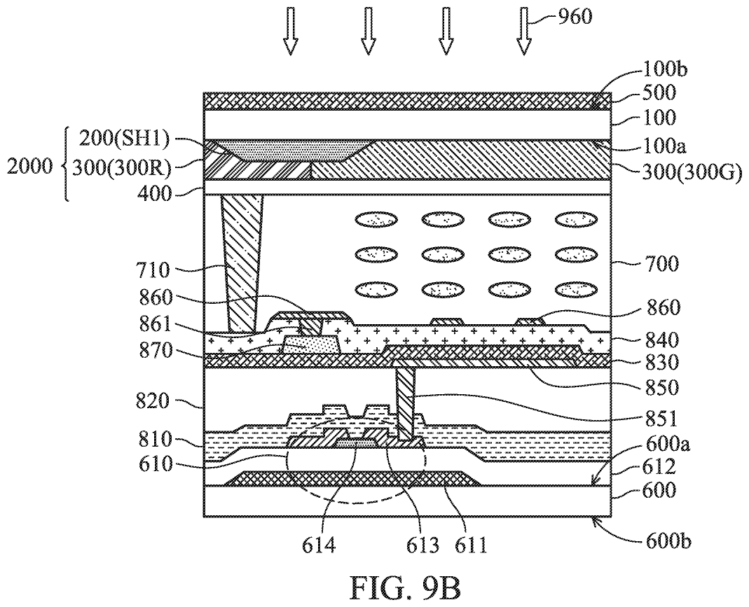

FIGS. 5-9B illustrate various stage of a manufacturing process of a display device in accordance with some embodiments of the present disclosure. It should be noted that in each of the cross-sectional views as shown in FIGS. 6A-7 and FIGS. 9A-9B, only a local region of the top views as shown in FIG. 5 and FIG. 8 is shown, for example, a sub-pixel region. The elements in the present embodiment sharing similar or the same labels with those in the previous embodiments are similar or the same elements, and the description of which is omitted.

Please refer to FIGS. 5-6A, a first base plate 100A is provided. The first base plate 100A has a first surface 100Aa and a second surface 100Ab opposite to the first surface 100Aa.

Next, please refer to FIG. 6A, a light-shielding material layer 200A including a black colorant is formed on the first base plate 100A. In some embodiments, for example, a composition for forming the light-shielding material layer 200A is coated on the first surface 100Aa of the first base plate 100A. In some embodiments, the light-shielding material layer 200A may further include a self-healing polymer material, so that the light-shielding material layer 200A may serve as a self-healing material layer including the self-healing polymer material.

Next, please refer to FIG. 6B, a pre-bake process 910 is performed on the light-shielding material layer 200A. In some embodiments, the pre-bake process 910 is performed at a temperature that is in a range from 50° C. to 150° C., e.g., about 100° C. to about 140° C.

Next, please refer to FIG. 6C, the light-shielding material layer 200A is patterned to form the light-shielding layer 200. Next, please refer to FIG. 6D, a post-bake process 920 is performed on the light-shielding layer 200. In some embodiments, the post-bake process 920 is performed at a temperature that is in a range from about 200° C. to about 230° C.

In some embodiments, the light-shielding layer 200 may be a self-healing layer including a self-healing polymer material, such that the pre-bake process 910 and the post-bake process 920 may serve as the self-healing process of the light-shielding layer 200 at the same time. This self-healing process can repair the defects, such as broken wires or indentation, which may be generated in the light-shielding layer 200. As such, the light-shielding layer 200 including the self-healing polymer material can be self-repaired in the existing processing steps of the manufacturing process of the display panel without requiring any additional repairing processes (e.g., cutting the defect position by laser to define a hole that requires repairing followed by filling a light-shielding material into the hole to complete the repairing process) in the manufacturing process. Accordingly, the manufacturing process is simplified, and/or the manufacturing yield is improved.

Next, please refer to FIG. 6E, a photoresist material layer 300A including a colorant is formed on the first base plate 100A. As shown in FIG. 6E, in some embodiments, the photoresist material layer 300A is formed on the first surface 100Aa of the first base plate 100A. In some embodiments, for example, a composition for forming the photoresist material layer 300A is coated on the first base plate 100A and the light-shielding layer 200.

Next, please refer to FIG. 6F, similar to the aforementioned processes performed on the light-shielding layer, a pre-bake process 930 is performed on the photoresist material layer 300A, the photoresist material layer 300A is patterned to form the green color resist 300G (FIG. 6G), and then a post-bake process 940 (FIG. 6H) is performed. Similarly, when the photoresist material layer 300A is a self-healing layer including a self-healing polymer material, the aforementioned pre-bake process 930 and the post-bake process 940 may serve to repair the defects in the photoresist material layer. As such, additional repairing processes are not required in the manufacturing process of the display panel, and the details are not repeated herein.

Next, please refer to FIG. 6I, in some embodiments, other portions of the color resist layer 300 (e.g., the red color resist 300R) may be formed by the processing steps similar to those shown in FIGS. 6E-6H.

In some embodiments, the composition for forming the light-shielding layer 200 may include about 5-10 wt % of a polymer material, about 5-10 wt % of a monomer, about 0-1 wt % of a photo initiator, about 0-1 wt % of a colorant, about 1-10 wt % of a self-healing polymer material, and about 70-90 wt % of a solvent, but the present disclosure is not limited thereto. When the aforementioned color resist layer 300 is a self-healing layer, the composition for forming the color resist layer 300 may also include the above constituents, and the details are not repeated herein.

Next, please refer to FIG. 6J, the planarization layer 400 including a transparent resin material is formed on the first surface 100Aa of the first base plate 100A. As shown in FIG. 6J, in some embodiments, the planarization layer 400 is formed on the first base plate 100A, the light-shielding layer 200, and the color resist layer 300. In some embodiments, for example, a composition for forming the planarization layer 400 is coated on the first surface 100Aa of the first base plate 100A, the light-shielding layer 200, and the color resist layer 300. In some embodiments, the planarization layer 400 further includes a self-healing polymer material, so that that the planarization layer 400 may serve as a self-healing layer including a self-healing polymer material. Next, please refer to FIG. 6K, similar to the aforementioned processes performed on the light-shielding layer, a pre-bake process 950 may be performed on the planarization layer 400 to repair any possible defects that the planarization layer 400 may have. As such, additional repairing processes are not required in the manufacturing process of the display panel, and the details are not repeated herein.

In some embodiments, the composition for forming the planarization layer 400 may include, for example, about 5-10 wt % of a polymer material, about 5-10 wt % of a monomer, about 0-1 wt % of a photo initiator, about 1-10 wt % of a self-healing polymer material, and about 70-90 wt % of a solvent, but the present disclosure is not limited thereto.

Next, please refer to FIG. 6L, the spacer 710 is formed on the first base plate 100A.

Next, please refer to FIG. 7, a second base plate 600A is provided, and an electronic component layer is disposed on the second base plate 600A. The electronic component layer may include the transistor component 610 and a pixel electrode. For example, as shown in FIG. 1, the electronic component layer may include the transistor component 610, the dielectric layer 810, the planarization layer 820, the pixel electrode 850, the dielectric layer 830, and the common electrode 860, but the present disclosure is not limited thereto. The materials, structures, and arrangements of these components are as aforementioned and are not repeated herein. In some embodiments, as shown in FIG. 7, the aforementioned components may be disposed on the first surface 600Aa of the second base plate 600A. In some embodiments, as shown in FIG. 7, the second base plate 600A further has a second surface 600Ab, and the second surface 600Ab is opposite to the first surface 600Aa.

According to some embodiments, as shown in FIG. 3, the electronic component layer disposed on the second base plate 600A may further include a touch electrode layer. For example, the electronic component layer may include the transistor component 610, the dielectric layer 810, the planarization layer 820, the pixel electrode 850, the dielectric layer 830, the common electrode 860, the dielectric layer 840, and the metal wiring layer 870, but the present disclosure is not limited thereto. The common electrode 860 may serve as a touch electrode layer at the same time. The materials, structures, and arrangements of these components are as aforementioned and are not repeated herein.

Then, refer to FIG. 7, the first base plate 100A coated with the self-healing layer is assembled to the second base plate 600A disposed with the electronic component layer thereon to form the base plate assembly M1, as shown in FIG. 7, and the first surface 100Aa of the first base plate 100A is facing towards the first surface 600Aa of the second base plate 600A when assembling. The base plate assembly that does not include a touch electrode layer is taken as an example in this embodiment. In some other embodiments, the base plate assembly may include the touch electrode layer 860.

Next, please refer to FIG. 8, the base plate assembly M1 is cut to form a plurality of display panels 10. For example, in some embodiments, the base plate assembly M1 including the first base plate 100A, the light-shielding layer 200, the color resist layer 300, the planarization layer 400, the electronic component layer, and the second base plate 600A is cut to form the display device 10 as shown in FIG. 1. Next, as shown in FIG. 1, the polarizer 20A may be adhered to the surface 100b of the first substrate 100 through the adhesive layer 30A, and the polarizer 20B may be adhered to the surface 600b of the second substrate 600 through the adhesive layer 30B.

As described previously, in some other embodiments, the base plate assembly may include the touch electrode layer 860. As shown in FIG. 9A, the electronic component layer may be formed on the second base plate 600A, the electronic component layer may further include the dielectric layer 840 and the metal wiring layer 870, and the common electrode 860 is disposed on the dielectric layer 840. In addition, the common electrode 860 may serve as a touch electrode layer at the same time. Next, the first base plate 100A coated with the color filter structure 2000 is assembled to the second base plate 600A disposed with the electronic component layer thereon, the first surface 100Aa of the first base plate 100A facing towards the first surface 600Aa of the second base plate 600A when assembling, and the antistatic layer 500 is coated on the surface 100Ab of the first base plate 100A, to construct a base plate assembly M2 as shown in FIG. 9A. The antistatic layer 500 may be the self-healing layer SH2. Under this situation, the color filter structure 2000 may include a self-healing layer or may not include any self-healing layer. In some embodiments, the antistatic layer 500 may further include a self-healing polymer material, so that the antistatic layer 500 may be a self-healing layer including the self-healing polymer material. According to some embodiments, in the base plate assembly M2 as shown in FIG. 9A, at least one or more than one of the light-shielding layer 200, the color resist layer 300, the planarization layer 400, and the antistatic layer 500 may be a self-healing layer including a self-healing polymer material. For convenience of description, the light-shielding layer 200 as shown in FIG. 9A is marked as the self-healing layer SH1, but the present disclosure is not limited thereto.

In some embodiments, the composition for forming the antistatic layer 500 may include, for example, about 1-2 wt % of a conductive polymer material, about 1-5 wt % of a binder, about 1-10 wt % of a self-healing polymer material, and about 80-90 wt % of a solvent (e.g., water and ethanol), but the present disclosure is not limited thereto.

Next, the base plate assembly M2 is cut to form a plurality of display devices 10 as shown in FIG. 9B.

In some embodiments, as shown in FIG. 9B, before a polarizer is disposed, a self-healing process 960 may be performed on the self-healing layer (e.g., at least one or more than one of the light-shielding layer 200, the color resist layer 300, the planarization layer 400, and the antistatic layer 500 may be the self-healing layer including a self-healing polymer material). In some embodiments, the self-healing process 960 includes placing the self-healing layer at room temperature for one minute or longer, for example, for one minute to one hour, for one minute to 24 hours, or for one minute to several days. In some embodiments, the self-healing process 960 may include heating the self-healing layer (e.g., at a temperature ranging from about 20° C. to about 50° C. or from about 20° C. to about 30° C.) or applying a radiation with a wavelength of about 100 nm to about 300 nm on the self-healing layer.

In some embodiments, the antistatic layer 500 may be a self-healing layer including a self-healing polymer material. The self-healing process 960 performed after the cutting step can facilitate the self-healing layer to repair itself, for example, the scratches on the antistatic layer 500 that are possibly generated in the process of cutting the base plate assembly can be repaired. As such, the issues where antistatic films break easily and the difficulties of repairing scratches can be solved effectively, and the manufacturing yield and/or performance can be effectively improved.

Next, the polarizer 20A can be adhered to the surface 100b of the first substrate 100 through the adhesive layer 30A, and the polarizer 20B can be adhered to the surface 600b of the second substrate 600 through the adhesive layer 30B, to form the display device 3 as shown in FIG. 3. According to some embodiments, the aforementioned self-healing process 960 may also be performed after adhering the polarizer 20A and the polarizer 20B.

The self-healing layer of the present disclosure has a self-healing ability. According to some embodiments, the evaluation method of the self-healing ability is as follows: applying a weight on a self-healing layer to initially generate a scratch, waiting for a period of time, and then observing the self-healing condition of the scratch. For example, a weight of 0.2-0.3 kg is applied on a self-healing layer to form an initial scratch with a width of equal to or greater than 0.03 mm, e.g., 0.03-0.08 mm. If the depth of the scratch is reduced, the width of the scratch is reduced, or the scratch disappears within a repairing time period, it is determined that the self-healing layer has the self-healing ability. The repairing time period may be, for example, one minute or longer, one minute to one hour, one minute to 24 hours, or one minute to several days. The extent of the reduction of the width of the scratch may be 90% or less of the width of the initial scratch, for example, 10-90%, 60-80%, or even less than 10%.

In the present disclosure, the components in the display device 1, the display device 2, the display device 3, and the display device 4 that are the same or similar are manufactured with the same or similar materials and/or by the same or similar processing steps. The detailed description is as aforementioned and is not repeated herein.

According to some embodiments, the self-healing layer coated on at least a surface of the base plate can undergo a self-healing process and thus can repair the defects of the coating layer in the display panel. According to some embodiments, when the self-healing layer is at least one layer in the color filter structure, the defects in the color filter structure can be repaired by processes such as pre-bake and/or irradiation without requiring any additional repairing processes. According to some embodiments, when the self-healing layer is an antistatic layer, the defects of the antistatic layer that are generated in the process of cutting the base plate assembly can be repaired.

Although some embodiments of the present disclosure and their advantages have been described in detail, it should be understood that various changes, substitutions and alterations can be made herein without departing from the spirit and scope of the disclosure as defined by the appended claims. For example, it will be readily understood by one of ordinary skill in the art that many of the features, functions, processes, and materials described herein may be varied while remaining within the scope of the present disclosure. In addition, the features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A display device, comprising:
a display panel, comprising:
a first substrate;
a second substrate;
a display medium layer disposed between the first substrate and the second substrate; and
a self-healing layer formed on at least a surface of the first substrate or the second substrate, wherein the self-healing layer comprises a self-healing polymer material; and
a polarizer disposed on the display panel.

2. The display device as claimed in claim 1, wherein the self-healing polymer material comprises a polyrotaxane material, a polyurethane (PU) material, a polyether-thiourea material, or a combination thereof.

3. The display device as claimed in claim 1, wherein the first substrate has a first surface facing towards the display medium layer and a second surface opposite to the first surface, wherein the self-healing layer is formed on at least one of the first surface and the second surface of the first substrate.

4. The display device as claimed in claim 3, wherein the self-healing layer comprises a first self-healing layer formed on the first surface of the first substrate and comprises a photoresist material.

5. The display device as claimed in claim 4, wherein the first self-healing layer further comprises a colorant.

6. The display device as claimed in claim 3, wherein the self-healing layer comprises a second self-healing layer formed on the second surface of the first substrate and comprises a conductive material.

7. The display device as claimed in claim 6, wherein the second self-healing layer is an antistatic layer.

8. The display device as claimed in claim 1, wherein the display panel further comprises a touch electrode layer.

9. The display device as claimed in claim 3, wherein the self-healing layer comprises a first self-healing layer formed on the first surface of the first substrate and comprises a transparent resin material.

10. The display device as claimed in claim 9, wherein the first self-healing layer has a planarized surface.

11. A manufacturing method of a display device, comprising:
providing a base plate assembly, the base plate assembly comprising:
a first base plate having a first surface and a second surface opposite to the first surface;
a second base plate; and
a self-healing layer coated on at least a surface of the first base plate or the second base plate, wherein the self-healing layer comprises a self-healing polymer material;
cutting the base plate assembly to form a plurality of display panels; and
disposing a polarizer on at least one of the plurality of display panels to form the display device.

12. The manufacturing method of the display device as claimed in claim 11, wherein providing the base plate assembly comprises:
coating the self-healing layer on the first surface of the first base plate; and
assembling the first base plate coated with the self-healing layer to the second base plate to form the base plate assembly, wherein the first surface of the first base plate is facing towards the second base plate when assembling.

13. The manufacturing method of the display device as claimed in claim 11, wherein providing the base plate assembly comprises:
assembling the first base plate to the second base plate to form the base plate assembly, wherein the first surface of the first base plate is facing towards the second base plate when assembling; and
coating the self-healing layer on the second surface of the first base plate of the base plate assembly.

14. The manufacturing method of the display device as claimed in claim 11, further comprising:
performing a self-healing process on the self-healing layer before disposing the polarizer.

15. The manufacturing method of the display device as claimed in claim 14, wherein performing the self-healing process comprises placing the self-healing layer at room temperature for one minute to several days.

16. The manufacturing method of the display device as claimed in claim 14, wherein performing the self-healing process comprises heating the self-healing layer at a temperature ranging from about 20° C. to about 50° C.

17. The manufacturing method of the display device as claimed in claim 14, wherein performing the self-healing process comprises applying a radiation with a wavelength of about 100 nm to about 300 nm on the self-healing layer.

18. The manufacturing method of the display device as claimed in claim 11, wherein the self-healing polymer material comprises a polyrotaxane material, a polyurethane (PU) material, a polyether-thiourea material, or a combination thereof.

19. The manufacturing method of the display device as claimed in claim 11, wherein the self-healing layer is coated on the first surface of the first base plate and comprises a photoresist material and a colorant.

20. The manufacturing method of the display device as claimed in claim 11, wherein the self-healing layer is coated on the second surface of the first base plate and comprises a conductive material.
